(19) United States
(12) Patent Application Publication
(10) Pub. No.: US 2016/0035063 A1
(43) Pub. Date: Feb. 4, 2016

(54) SCALING DATA AUTOMATICALLY

(71) Applicant: Lenovo (Singapore) Pte. Ltd., Singapore (SG)

(72) Inventors: John Carl Mese, Cary, NC (US); Russell Speight VanBlon, Raleigh, NC (US); Nathan J. Peterson, Durham, NC (US); Arnold S. Weksler, Raleigh, NC (US)

(21) Appl. No.: 14/446,490

(22) Filed: Jul. 30, 2014

(51) Int. Cl. G06T 3/40; G06F 3/0484

(52) U.S. Cl. CPC G06T 3/40; G06F 3/04847

(57) ABSTRACT

One embodiment includes, but is not necessarily limited to, a method, comprising: displaying, using a display device, data; detecting, using a processor, the data does not meet at least one visibility criterion; and automatically scaling, using a processor, the data to a predetermined viewable size. Other embodiments are described and claimed herein.

### BACKGROUND

Information handling devices, for example, laptop computers, flat panel displays, smart televisions, tablet devices, smart phones, and the like are regularly used for viewing data (images, text, etc.). Sometimes the user will use one information handling device to retrieve the data and use another information handling device to view the data. For example, the user will populate the data on a laptop and display the data on a television screen.

With the abundance of display devices (e.g., flat panel displays, smart phone displays, monitors, televisions, etc.) available for a user to view data, with each having their own resolution and display size, a user is likely to have to resize the data that they are attempting to view. For example, if a user is viewing a web page on a smart phone with a high resolution, the web page may be displayed with text so small that the user is unable to read the text. The user may then need to resize the webpage, for example by zooming in on the text, changing the screen resolution, increasing the font size, and the like, to make the text readable.

### BRIEF SUMMARY

In summary, one aspect provides a method, comprising: displaying, using a display device, data; detecting, using a processor, the data does not meet at least one visibility criterion; and automatically scaling, using a processor, the data to a predetermined viewable size.

A further aspect provides an information handling device, comprising: a display device; at least one processor operatively coupled to the display device; and a memory device that stores instructions executable by the processor to: display, using the display device, data; detect the data does not meet at least one visibility criterion; and automatically scale the data to a predetermined viewable size.

Another aspect provides a product, comprising: a storage device having code stored therewith, the code comprising: code that displays, on a display device, data; code that detects, using a processor, the data does not meet at least one visibility criterion; and code that automatically scales, using a processor, the data to a predetermined viewable size.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example for scaling data automatically.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Users have a variety of information handling devices, for example smart phones, tablets, personal computers, televisions, and the like, on which to view data (e.g., text, images, videos, etc.). These information handling devices have displays, each having their own resolution (i.e., the number of distinct pixels that can be displayed, sometimes measured by pixels per inch (PPI) or dots per inch (DPI)). As technology advances, display resolution is continually getting higher. Higher resolution enables sharper text and images, but may also cause a user to have resize a window to reach an optimal viewing resolution. The term window is used for simplicity and is intended to encompass the entire screen (i.e., the entire viewing area), window (i.e., a graphical control element), frame (i.e., a part of a web page or browser which displays data/content independent of its container), and the like. For example, it is common for a web page to be rendered, on a smart phone, with text so small that a user must zoom to read it. Alternatively, connecting to a display with a lower resolution than the last one used, may cause the data to be too large, requiring the user to reduce the size to a comfortable size.

Additionally, a user may have a hard time viewing data/content because of the user's environment. For example, if a user is viewing a display in direct sunlight, the display may be hard to see because of the glare. Some information handling devices may change the brightness of the screen to account for this. However, another method to assist in viewing the data/content may be to increase the size of the data/content. If data/content is rendered on the display with poorly contrasting colors, the data/content may be hard to view. For example, if the text in a document is yellow and the background color is white, the text may be difficult to read. Increasing the size of the data/content may assist the user in viewing such data/content.

Unfortunately, in most cases, a user must make a manual adjustment in order to resize a window. For example, a user may use zoom and pinch on some touch displays to increase and decrease a window size, manually change the resolution setting for the operating system, increase or decrease the font size, and the like. Additionally, such resizing must be done every time a user accesses a webpage, application, or other such environment, in which the viewable data/content is rendered unviewable (e.g., the data/content is too large or too small, the environment lighting causes smaller data/content to be hard to view, color schemes that make the data/content hard to view, etc.). Resizing must also be completed if a user renders the data on one information handling device and then projects this data onto another device. For example, if a user is using their smart phone to watch a video but then wants to project the video on a computer screen, the user must adjust the resolution of one of the devices to allow for optimal viewing of the video.

Accordingly, an embodiment provides a method for detecting whether data displayed on a display device meets one or more visibility criterion. One embodiment may additionally identify the content, contained within the data, the user is attempting to view. If an embodiment detects that the data or content does not meet a visibility criterion (e.g., viewable size, appropriate contrast, brightness, etc.), an embodiment may automatically scale the window/frame that the data/content is contained within to make the data/content of a viewable size. In an embodiment that identifies the content the user is attempting to view, an embodiment may identify the content the user is most likely trying to view by parsing the content. Additionally or alternatively, an embodiment may identify the content by tracking the user's gaze and determining where the user is looking. One embodiment may also allow the user to override the automatic scaling. If a user indicates that scaling is not desired, an embodiment may revert the data/content back to the originally presented size.

The illustrated example embodiments will be best understood by reference to the figures. The following description is intended only by way of example, and simply illustrates certain example embodiments.

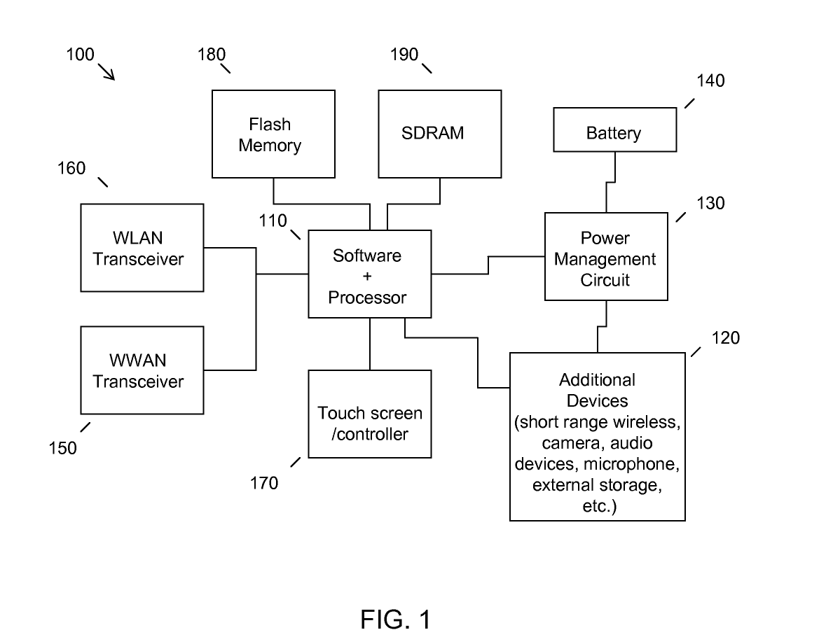

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120), for example a keyboard, camera, microphone, and the like, may attach to a single chip 110. The circuitry 100 combines the processor, memory control and I/O controller hub all into a single chip 110. Also, systems 100 of this type do not typically use SATA or PCI or LPC. Common interfaces, for example, include SDIO and 12C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., such as a camera, microphone, audio device, or other input devices. System 100 often includes a touch screen 170 for data input and display/rendering. System 100 also typically includes various memory devices, for example flash memory 180 and SDRAM 190.

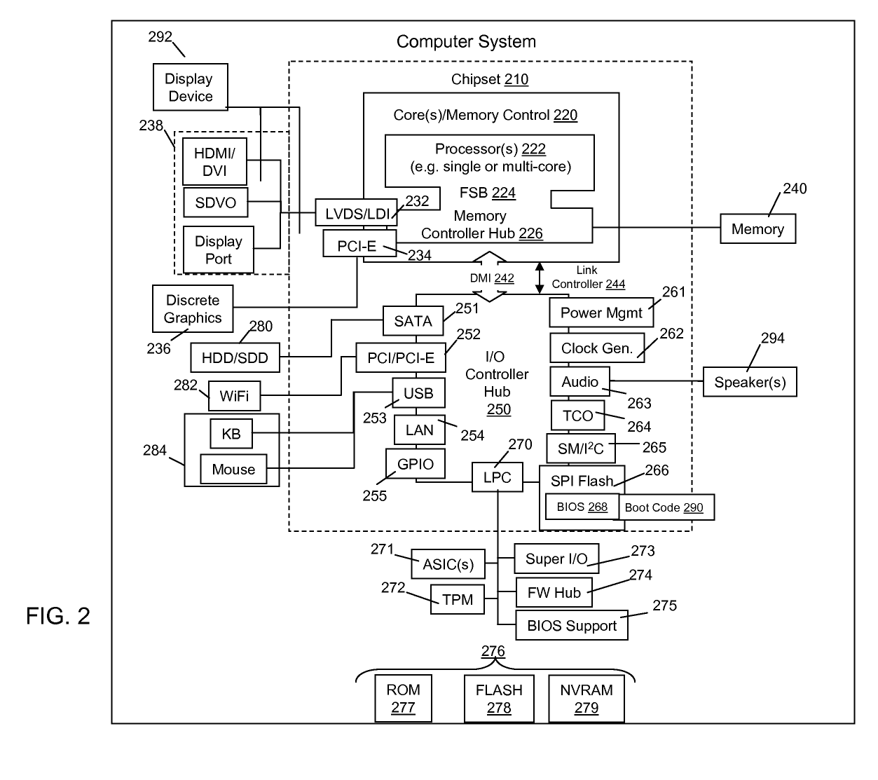

FIG. 2 depicts a block diagram of another example of information handling device circuits, circuitry or components. The example depicted in FIG. 2 may correspond to computing systems such as the THINK PAD series of personal computers sold by Lenovo (US) Inc, of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.), INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a LVDS interface 232 for a display device 292 (for example, a flat panel display, touch screen, monitor, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub con roller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, external display devices, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or other electronic devices which users use to view data. For example, the circuitry outlined in FIG. 1 may be implemented in a tablet or smart phone embodiment, whereas the circuitry outlined in FIG. 2 may be implemented in a personal computer embodiment.

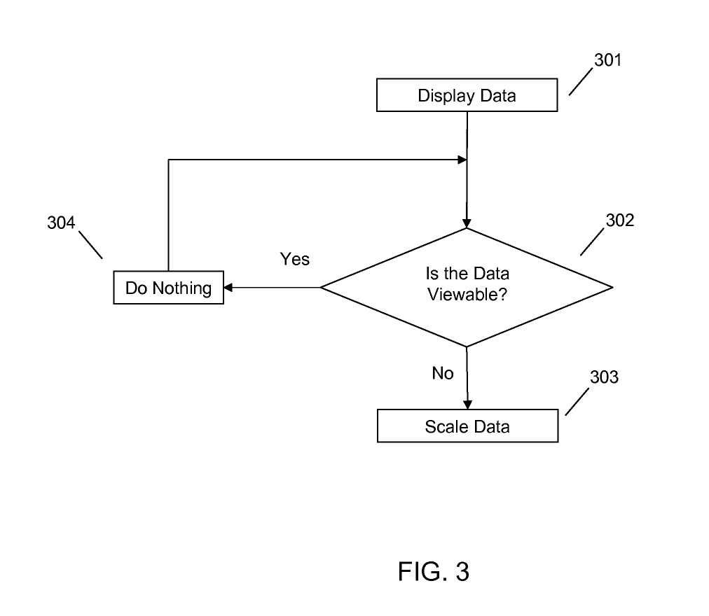

Referring now to FIG. 3, an embodiment may at 301 display data (e.g., video, pictures, text, applications, etc.) on a display device, for example, a monitor, television, display included on an information handling device (e.g., a smart phone, tablet, laptop computer, etc.), touch display, and the like.

At 302, an embodiment may determine whether the data is viewable (i.e., whether the data meets one or more visibility criterion). If the data is viewable, then an embodiment may do nothing at 304. If an embodiment detects that the data/content is not viewable at 302, then an embodiment may automatically scale the data/content to a. predetermined viewable size at 303.

The predetermined viewable size may be derived from one or multiple sources. In one embodiment, the predetermined size may be derived, at least in part from, the resolution of the display device. For example, an embodiment may detect that the resolution for the display device is 1024×768. An embodiment may then use this information to scale the data/content to a size that is viewable at this resolution level. Additionally or alternatively, in an embodiment the predetermined size may be derived, at least in part from the physical size of the display device. For example, an embodiment may detect the physical size of the display device is five inches wide by three inches tall. An embodiment may use this information to scale the data/content to a size that is viewable using a display this size.

One embodiment may derive the predetermined viewable size at least in part from the user. For example, a user may manually set the viewable size of a window, in a graphical user interface or by some other method, for a type of application. An embodiment may use this setting to scale the windows any time that type of application is accessed. Additionally, or alternatively, an embodiment may determine the viewable size using a user's history. For example, an embodiment may “learn” that the user prefers the scaling to be of a larger size than what an embodiment has determined is readable and may use this information to scale data/content to the larger size preferred by the user. In another example, the user may manually adjust the size of the window and an embodiment may automatically scale all similar data/content to the same size. For example, if the user accesses a web page and adjusts the size of the window for that webpage, an embodiment may remember this adjustment and use it to determine the viewable size for all web pages.

One embodiment may identify the user to derive the predetermined size, One way this identification may be accomplished is by associating a user with entered user credentials. For example, if a user logs into an information handling device, an embodiment may use this information to determine the size the data needs to be for that particular user to view the data. For example, an embodiment may detect that User A has logged into their smart phone. Based upon past history, User A prefers that the data be of a larger size. An embodiment may use this information to scale the data to a larger size.

The identification may also be accomplished by using biometric data (e.g., fingerprints, voice identification, etc.) or captured image data. For example, an embodiment may use an image capture device to determine that a particular user is using the information handling device. An embodiment may then use this data to determine the predetermined viewable size that is associated with this user. For example, an embodiment may detect that User A is viewing data on an information handling device and may scale the data to a larger size. An embodiment then detects that User B is now viewing the same data on the same information handling device. An embodiment may then rescale the data based upon this new user. As a further example, an embodiment may detect that User A is logged into an information handling device, but it is actually User C who is viewing the data. Based upon User C viewing the data, an embodiment may scale the data to a “normal” size rather than the larger size that User A prefers. An embodiment may also associate different users with different profiles. In other words, an embodiment may learn and maintain separate settings for multiple users, rather than just maintaining a single user profile and a default profile.

Additionally, one embodiment may identify the user and then identify a particular attribute of that user to determine the viewable size. For example, an embodiment may determine that a user is wearing glasses and scale the data based upon this attribute. For example, User D usually wears glasses and prefers the data scaled to a particular size. However, an embodiment detects that User D is not wearing glasses and therefore scales the data to a different size. As another example, an embodiment may also determine that a user is wearing a specific pair of glasses. For example, an embodiment may detect that the user is wearing their reading glasses rather than their multiple purpose glasses. An embodiment may scale the data/content differently depending on the type of glasses the user is wearing, even if it is the same user wearing different glasses. Additional attributes may include, for example, glasses, contacts, specific glasses, the time of day (e.g., a user may prefer larger data later in the day), and other attributes which may affect the desired size of the data.

One embodiment may derive the predetermined viewable size at least in part from the application. For example, if the user is accessing an email program, an embodiment may determine that it is an email program. An embodiment may then scale the data into a readable format based upon the application running, which is an email program. In other words, an embodiment may determine that an email application needs a specific amount of scaling because of the data that would be viewed within the email application (e.g., an inbox view, a read message view, a send message view, etc.).

One embodiment may identify content, included within the data, that the user is viewing or trying to view. In one embodiment, this identification may be accomplished by determining, using characteristics included in the data, the content which has the highest probability of being viewed. In other words, based upon characteristics of the data, for example, if the data is an image, if the data is text, whether there is a combination of text and images, the type of window that is open (e.g., an email application with a reply to message window open, a website with a pop-up window for user input, etc.), the website or application that is being used (e.g., email application, news website, word processing application, etc.), and the like, an embodiment may identify which content included within the window is likely being viewed. For example, if the user has opened a webpage which includes a news article and advertisements, an embodiment may determine that the user is likely trying to view the news article rather than the advertisements. One embodiment may parse the data to determine what characteristics the data includes.

Alternatively or additionally, one embodiment may use an image capture device (e.g., camera, camera included on an information handling device, etc.) to determine where the user is looking to identify the content. For example, an embodiment may use a camera included on a smart phone to track the movement of the user's eyes to identify where the user is looking. An embodiment may then correlate the location of the user's gaze to a location within the data to determine what content the user is viewing.

An example embodiment may receive a user input overriding the automatic scaling, for example, the user trying to resize the window, the user manually selecting an override, and the like. One embodiment may display a graphical user interface allowing the user to override the automatic scaling. For example, an embodiment may display a graphical user interface after automatic scaling asking the user if they would like to keep the automatically scaled view. If the user overrides the automatic scaling, an embodiment may revert the data or content back to the originally displayed size.

Accordingly, as illustrated by the example embodiments and the figures, an embodiment provides a method for automatically scaling data to a viewable size. One embodiment may identify the content a user is likely trying to view, for example, by eye tracking, parsing the data, other characteristics contained in the data, and the like. An embodiment may detect that the data or content does not meet one or more visibility criterion and automatically scale the data or content to a predetermined viewable size. The predetermined viewable size may be based upon a number of inputs, including, but not limited to, user input, display resolution size, physical display size, or based on the type of application that is being accessed by the user. An embodiment may also allow the user to override the automatic scaling and revert back to the size that was originally displayed. Thus, allowing a user to view any data or content on any information handling device and the content the user is trying to view will be of a viewable size without the user having to manually adjust any settings.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages or may include machine language. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided o a processor of a general purpose information handling device, a special purpose information handling device, or other programmable data processing device to produce a machine, such that the ins ructions, which execute via a processor of the device implement the functions/acts specified.

It is worth noting that white specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
displaying, using a display device, data;
detecting, using a processor, the data does not meet at least one visibility criterion; and
automatically scaling, using a processor, the data to a predetermined viewable size.

2. The method of claim 1, further comprising identifying content included within the data that a user is viewing by detecting user image data captured via an image capture device.

3. The method of claim 1, further comprising determining, using characteristics included in the data, content within the data which has the highest probability of being viewed.

4. The method of claim 3, wherein the determining comprises parsing the data.

5. The method of claim 1, wherein the predetermined viewable size is derived at least in part from the resolution of the display device.

6. The method of claim 1, wherein the predetermined viewable size is derived at least in part from a user.

7. The method of claim 6, wherein the predetermined viewable size is derived at least in part from a user history.

8. The method of claim 1, further comprising:
identifying a particular user is viewing the data;
wherein the automatically scaling comprises automatically scaling the data to a predetermined viewable size associated with the particular user.

9. The method of claim 8, wherein the identifying a particular user comprises identifying an attribute of the particular user.

10. The method of claim 1, wherein the predetermined viewable size is derived at least in part from the size of the display device.

11. The method of claim 1, wherein the data comprises data from an application; and
wherein the predetermined viewable size is derived at least in part from the application.

12. The method of claim 1, further comprising:
receiving a user input overriding the automatic scaling; and
reverting to the size originally displayed.

13. An information handling device, comprising:
a display device;
at least one processor operatively coupled to the display device; and
a memory device that stores instructions executable by the processor to:
display, using the display device, data;
detect the data does not meet at least one visibility criterion; and
automatically scale the data to a predetermined viewable size.

14. The information handling device of claim 13, wherein the instructions are further executable by the processor to identify content included within the data that a user is viewing by detecting user image data captured via an image capture device.

15. The information handling device of claim 13, wherein the instructions are further executable by the processor to determine, using characteristics included in the data, content within the data which has the highest probability of being viewed.

16. The information handling device of claim 13, wherein the predetermined viewable size is derived at least in part from the resolution of the display device.

17. The information handling device of claim 13, wherein the predetermined viewable size is derived at least in part from a user.

18. The information handling device of claim 13, wherein the instructions are further executable by the processor to identify a particular user is viewing the data;
wherein to automatically scale comprises to automatically scale the data to a predetermined viewable size associated with a particular user.

19. The method of claim 18, wherein to identify a particular user comprises identifying an attribute of the particular user.

20. The information handling device of claim 13, wherein the predetermined viewable size is derived at least in part from the size of the display device.

21. The information handling device of claim 13, wherein the data comprises data from an application; and
wherein the predetermined viewable size is derived at least in part from the application.

22. The information handling device of claim 13, wherein the instructions are further executable by the processor to:
receive a user input overriding the automatic scaling; and
revert to the size originally displayed.

23. A product, comprising:
a storage device having code stored therewith, the code comprising:
code that displays, on a display device, data;
code that detects, using a processor, the data does not net at least one visibility criterion; and
code that automatically scales, using a processor, the data to a predetermined viewable size.
